(19) United States
(12) Patent Application Publication
(10) Pub. No.: US 2026/0287834 A1
(43) Pub. Date: Sep. 24, 2026

(54) OPTICAL MODULE INCLUDING LID

(71) Applicant: Global Technology Inc., Ningbo (CN)

(72) Inventors: Jian-Hong LUO, Ningbo (CN); Jiahang SHAO, Ningbo (CN); Di WANG, Ningbo (CN); Lin CHEN, Ningbo (CN)

(21) Appl. No.: 19/256,825

(22) Filed: Jul. 1, 2025

(30) Foreign Application Priority Data
Mar. 20, 2025 (CN) 202510340821.8

(51) Int. Cl. G02B 6/42; G02B 6/12

(52) U.S. Cl. CPC G02B 6/4249; G02B 6/12004; G02B 6/4204; G02B 6/4251; G02B 6/4257; G02B 2006/1204; G02B 2006/12061; G02B 2006/12121; G02B 2006/12123; G02B 2006/12138; G02B 2006/12157

(57) ABSTRACT

The present disclosure provides an optical module including a lid. The optical module includes a substrate, a metal base, a lid, an active optical component, and a passive optical component. The metal base is coupled to the substrate. The lid has a annular bottom surface. The annular bottom surface is monolithically coupled to the metal base to define a covered area and an exposed area on one side of the metal base. The annular bottom surface surrounds the covered area. The active optical component is coupled to the metal base and disposed within the covered area. The passive optical component is coupled to the metal base and disposed within the exposed area.

### CROSS-REFERENCE TO RELATED APPLICATIONS

This non-provisional application claims priority under 35 U.S.C. § 119(a) on Patent Application No(s). 202510340821.8 filed in China on Mar. 20, 2025, the entire contents of which are hereby incorporated by reference.

### BACKGROUND

### 1. Technical Field

This disclosure relates to an optical module including lid.

### 2. Related Art

An optical module can emit and/or receive optical signal in order to apply it in, for example, but not limited to, data center, cable television, and fiber to the home (FTTH). The use of optical modules provides higher transmission rates and signal bandwidth in longer transmission distances. To promote global compatibility of the optical interconnect products and to reduce maintenance complexity, organizations such as Multi-Source Agreements (MSA), the Institute of Electrical and Electronics Engineers (IEEE), and the Optical Internetworking Forum (OIF) have established various form factors for different signal transmission rates. These form factors include, but are not limited to, XFP, SFP, QSFP (Quad Small Form Factor Pluggable), QSFP-DD (Double Density), OSFP (Octal Small Form Factor Pluggable), and CPO (Co-Packaged Optics).

Conventional optical modules face challenges in reliability, manufacturing cost, optical power, space management, and thermal management.

### SUMMARY

According to one embodiment of this disclosure, an optical module includes a substrate, a metal base, a lid, an active optical component and a passive optical component. The metal base is coupled to the substrate. The lid has an annular bottom surface. The annular bottom surface is monolithically coupled to the metal base to define a covered area and an exposed area at a side of the metal base. The annular bottom surface surrounds the covered area. The active optical component is coupled to the metal base. The passive optical component is coupled to the metal base. The active optical component is disposed within the covered area, and the passive optical component is disposed within the exposed area.

According to another embodiment of this disclosure, an optical module includes a substrate, a metal base, a lid, an active optical component and a passive optical component. The metal base is coupled to the substrate. The lid has an annular bottom surface. The annular bottom surface is monolithically coupled to the metal base via soldering so that the lid and the metal base together form a hermetic space. The active optical component is coupled to the metal base and disposed within the hermetic space. The passive optical component is coupled to the metal base and disposed outside the hermetic space.

According to the embodiment of the optical module disclosed in this disclosure, by coupling the active optical component in the covered area and the passive optical component in the exposed area, it is possible to reduce manufacturing costs while maintaining the reliability of the optical module. Moreover, this packaging method is compatible with optical modules for different applications.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a three-dimensional schematic diagram of an optical transmission component according to an embodiment of the present disclosure;

FIG. 2 is a side view of the optical transmission component shown in FIG. 1;

FIG. 3 is an exploded diagram of the optical transmission component shown in FIG. 1;

FIG. 4 is a bottom view of the lid of the optical transmission component shown in FIG. 3;

FIG. 5 is another side view of the optical transmission component shown in FIG. 1;

FIG. 6 is an enlarged view of the feedthrough device shown in FIG. 3;

FIG. 7 is a side view of an optical module according to another embodiment of the present disclosure;

FIG. 8 is a partially enlarged top view of the optical module shown in FIG. 7;

FIG. 9 is a side view of an optical module according to yet another embodiment of the present disclosure; and

FIG. 10 is a partially enlarged top view of the optical module shown in FIG. 9.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present disclosure. The following embodiments further illustrate various aspects of the present disclosure, but are not meant to limit the scope of the present disclosure.

With the rapid development of artificial intelligence technology, the market demand for multi-channel high-speed optical modules has significantly increased. At the same time, the reliability of high-speed optical modules under harsh environments has become increasingly important. To meet stringent environmental requirements, optical components typically adopt hermetic sealing. The inventors have recognized that heat sources in optical modules often need to be cooled using thermoelectric cooler (TEC) to ensure acceptable functions. During the cooling process, because condensation may occur, it is necessary to adopt a hermetic structure to protect the optical module, thereby ensuring the performance and lifespan of the optical components. However, in a design of an optical module known to the inventors, the active optical component and most of the passive optical components are enclosed within a hermetically sealed structure, such that both components are sealed within a box-shaped element. More specifically, the known sealing method involves a BOX packaging, in which the optical components are placed in a metal enclosure including a bottom portion, and this enclosure is then mounted on a base. Since the optical components should be arranged on the bottom portion in advance, this packaging approach does not allow for adjustments during manufacturing for different product types, As a result, the known BOX packaging suffers from poor compatibility, limits process flexibility, and increased manufacturing costs.

According to an embodiment of the present disclosure, by coupling the active optical component to the covered area and coupling the passive optical component to the exposed area, it is favorable to reduce manufacturing costs while maintaining the reliability of the optical module. Moreover, this configuration is compatible with optical modules having different specifications. More specifically, according to an embodiment of the present disclosure, a lid having an annular bottom surface is coupled to a metal base to form a space for accommodating optical components. Therefore, during the manufacturing process, specific optical components are first arranged at predetermined positions on the metal base according to product specifications, and then the lid is placed to seal the optical components. Since optical modules with different specifications can be assembled using a base and lid of a single size, this design enhances process flexibility.

A person skilled in the art may reasonably combine and arrange the following disclosed technical features to achieve the corresponding technical effects.

The terms “coupled” or “coupling” refers to any connection, linkage, or similar relationship. The term “optically coupled” or “optically coupling” refers to a relationship in which light is imparted from one component to another component. Unless otherwise specified, components that are coupled to or coupling with each other do not need to be directly connected to each other and may be spaced apart via one or more intermediate components.

The term “substantially” refers to a degree of precision within an acceptable margin of error, wherein the acceptable margin reflects minor real-world variations resulting from material compositions, material imperfections, and/or limitations/peculiarities in the manufacturing process. Such variations may be described as achieving the stated characteristic to a significant extent, without necessarily achieving it in absolute terms.

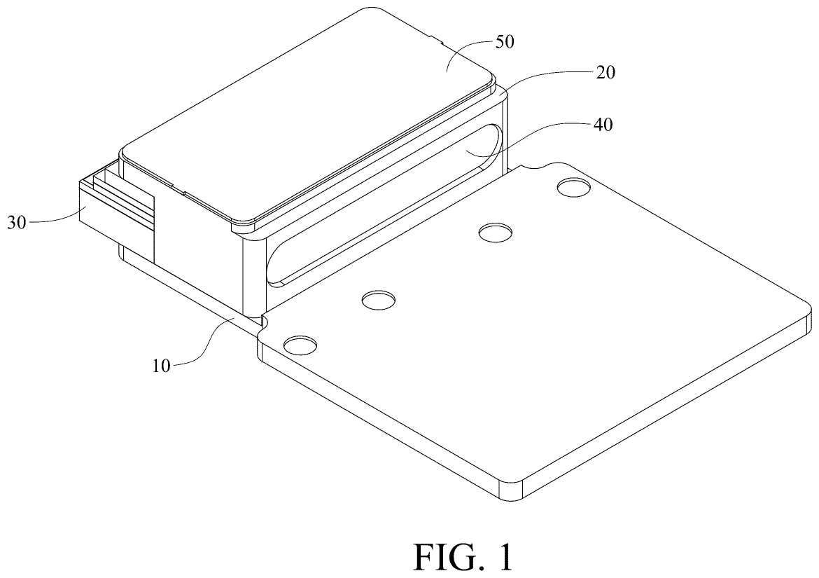

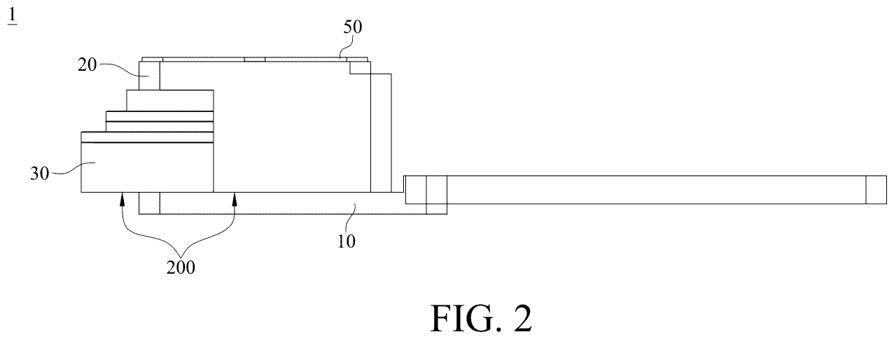

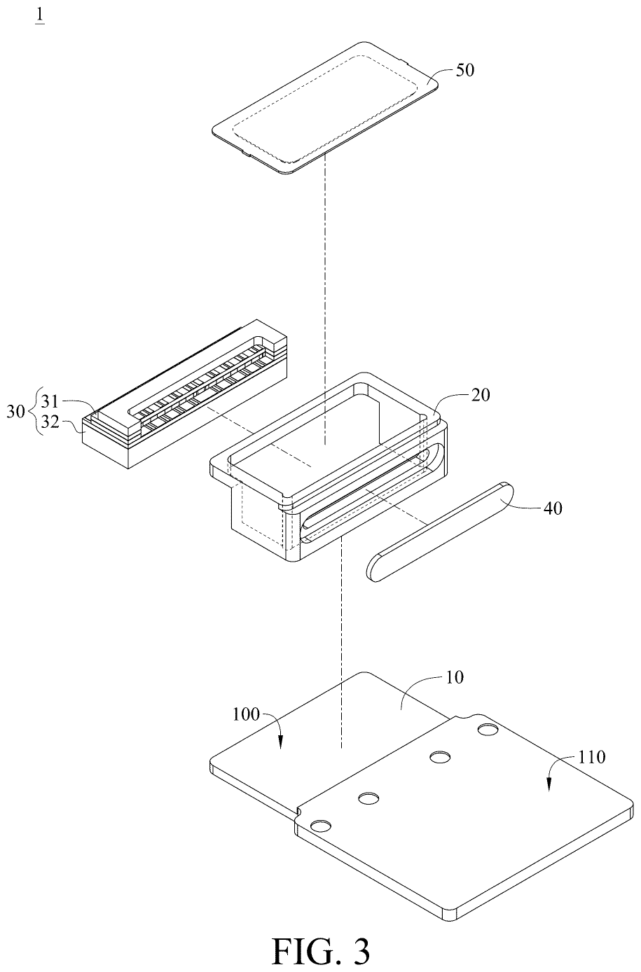

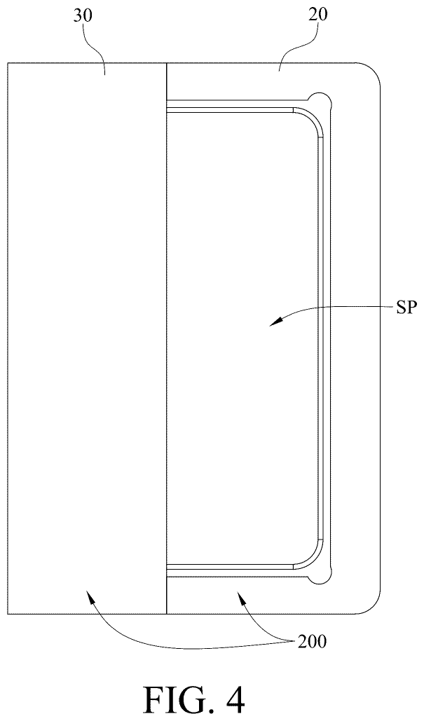

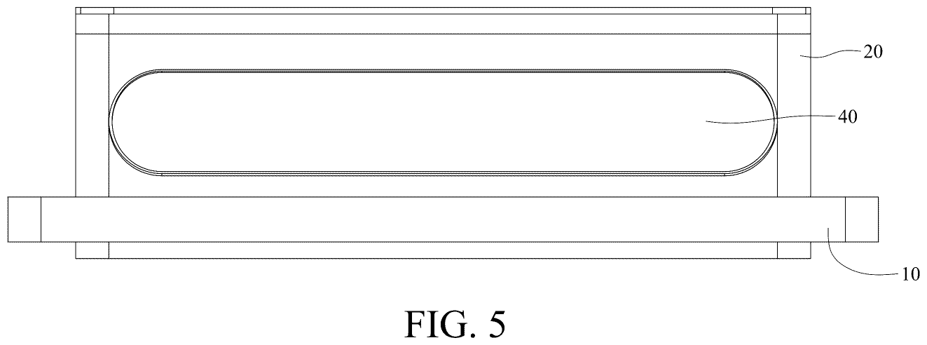

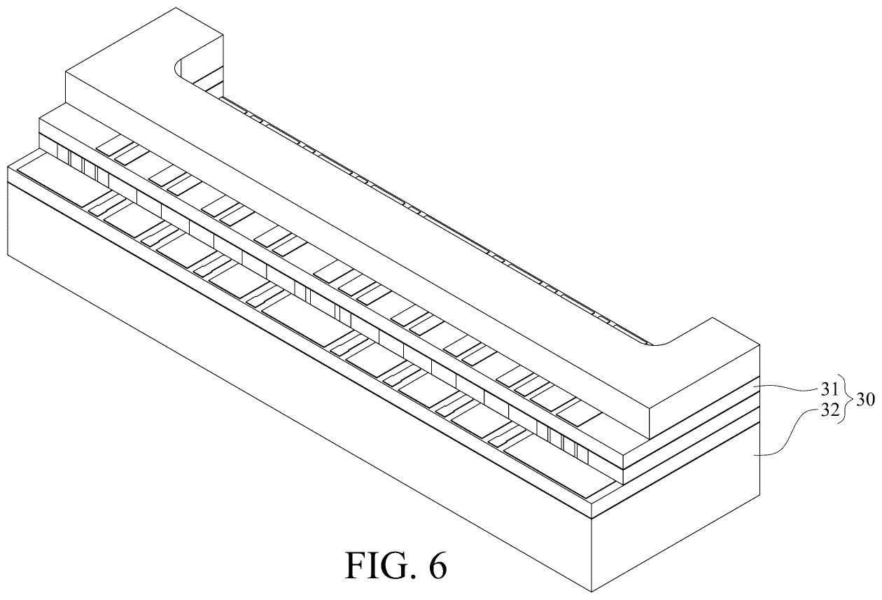

FIG. 1 is a three-dimensional schematic diagram of an optical transmission component according to an embodiment of the present disclosure. FIG. 2 is a side view of the optical transmission component shown in FIG. 1. FIG. 3 is an exploded diagram of the optical transmission component shown in FIG. 1. FIG. 4 is a bottom view of the lid of the optical transmission component shown in FIG. 3. FIG. 5 is another side view of the optical transmission component shown in FIG. 1. FIG. 6 is an enlarged view of the feedthrough device shown in FIG. 3. According to one embodiment, the optical transmission component 1 may include a metal base 10, a lid, an active optical component, and a passive optical component.

In one embodiment, the lid may be coupled to the metal base 10 by soldering. In one embodiment, the lid and the metal base 10 may together form a hermetic space, such that the active optical component is sealed within the hermetic space.

In one embodiment, the active optical component may be coupled to the metal base 10. In one embodiment, the active optical component may include multiple optical communication units, such as one or more optical transmitting units and/or one or more optical receiving units, and these optical communication units may be located on the same horizontal plane. Each optical transmitting unit may include one or more laser diodes, and each optical receiving unit may include one or more photodiodes. In one embodiment, the laser diodes or photodiodes may be mounted on a submount. In one embodiment, the laser diodes may be mounted on a TEC. In one embodiment, the optical transmitting units and optical receiving units may each be integrated in a silicon photonics chip or a lithium niobate chip. In one embodiment, the active optical component may further include circuitry for transmitting radio frequency (RF) signals to the optical transmitting units. In one embodiment, each optical transmitting unit together with corresponding passive optical component(s) may be understood as a transmitter optical subassembly (TOSA), and each optical receiving unit together with corresponding passive optical component(s) may be understood as a receiver optical subassembly (ROSA).

In one embodiment, the passive optical component may be coupled to the metal base 10. In one embodiment, the passive optical component may be but not limited to, for example, a fiber array, an optical isolator, a Z-block, and a collimator.

In one embodiment, the active optical component and the passive optical component may be coupled to the same metal base 10. In one embodiment, the active optical component and the passive optical component may be disposed on the same optical plane to ensure optical coupling efficiency between the active optical component and the passive optical component. The term “on the same optical plane” refers to the condition in which the optical path is linear and not folded. For example, as shown in FIG. 2, the metal base 10 has a stepped structure, such as a first top surface and a second top surface with different horizontal heights. The active optical component is coupled to the lower first top surface, and the passive optical component is coupled to the higher second top surface, such that they are on the surfaces of different heights. In this case, an optical bench may be provided on the first or second top surface so that the active optical component and the passive optical component are on the same optical plane.

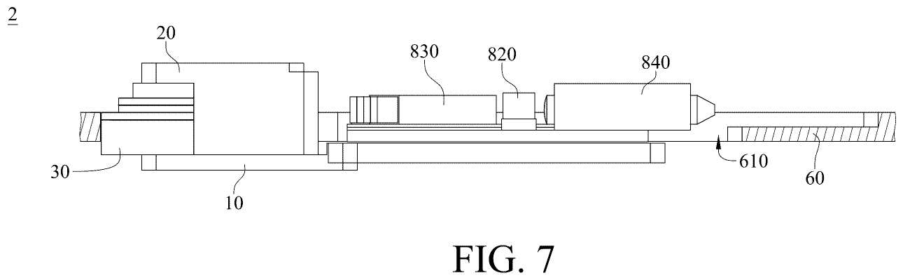

In one embodiment, the lid may have a annular bottom surface 200. In one embodiment, the annular bottom surface 200 may be monolithically coupled to the metal base 10 to define a covered area 100 and an exposed area 110 on one side of the metal base 10. The term “monolithically coupled” refers that the annular bottom surface 200 does not contact any area of a substrate, such as a printed circuit board assembly (PCBA). In one embodiment, referring to FIG. 7 to FIG. 10, the entire area of the annular bottom surface 200 may be coupled to the surface of the metal base 10. In one embodiment, the annular bottom surface 200 may protrude from an edge of the metal base 10 to be proximate to an edge of a through opening 610 in the substrate 60. In one embodiment, the annular bottom surface 200 may surround the covered area 100. In one embodiment, the annular bottom surface 200 may be monolithically coupled to the metal base 10 through solder such as metal tin, so that the lid and the metal base 10 together form a hermetic space SP. In one embodiment, the active optical component, which is susceptible to environmental factors such as temperature and humidity, may be disposed within the covered area 100, and the passive optical component, which is less susceptible to such factors, may be disposed in the exposed area 110. In one embodiment, the active optical component may be disposed inside the hermetic space SP. In one embodiment, the passive optical component may be disposed outside the hermetic space SP.

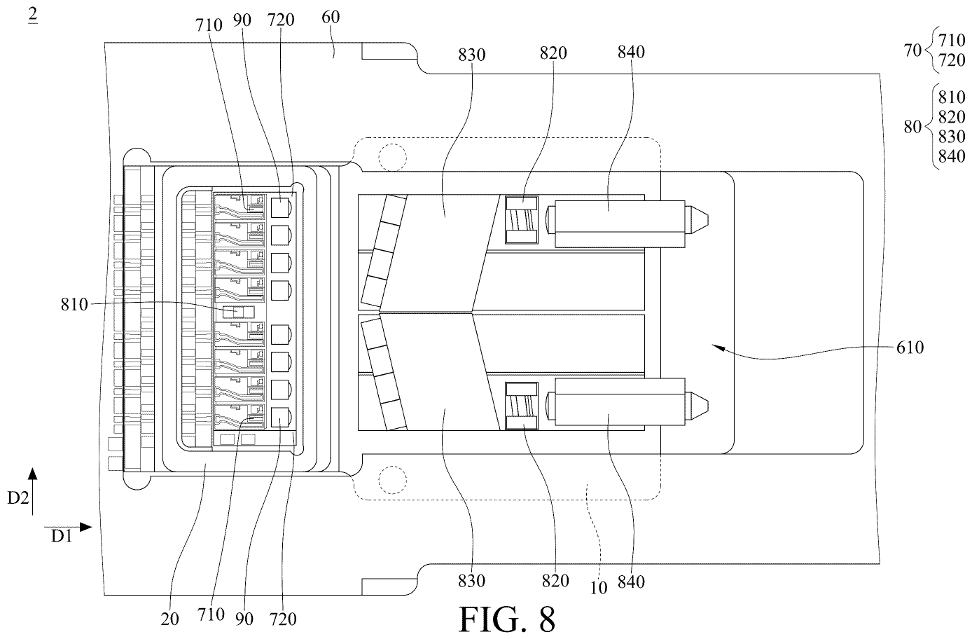

In one embodiment, the lid may include a housing 20. In one embodiment, the housing 20 may have at least a portion of the annular bottom surface 200. In one embodiment, the housing 20 may have a transverse dimension larger than that of the annular bottom surface 200 (e.g., the dimension along the lateral direction D2 shown in FIG. 8), such that the housing 20 may extend above the top surface or below the bottom surface of the substrate. In one embodiment, the lid may further include a feedthrough device 30 and a top cover 50. In one embodiment, the housing 20 and the feedthrough device 30 may be coupled to the metal base 10. In one embodiment, the housing 20 may include at least one light transmission window 40. In one embodiment, the active optical component may be optically coupled to the passive optical component through the at least one light transmission window 40. In one embodiment, the feedthrough device 30 may have a stepped shape. In one embodiment, the top cover 50 may be bonded to the top of the housing 20. In one embodiment, the housing 20 and the top cover 50 may be monolithically formed as a single piece. In one embodiment, the housing 20 and the feedthrough device 30 may together form the annular bottom surface 200. For example, as shown in FIG. 4, a U-shaped bottom surface of the housing 20 forms a first portion of the annular bottom surface 200, and a bottom surface of the feedthrough device 30 forms a second portion of the annular bottom surface 200. In another embodiment, the feedthrough device 30 may extend through a lateral portion of the housing 20, and the housing 20 forms the entire annular bottom surface 200.

In one embodiment, referring to FIG. 3 and FIG. 4, before the lid is coupled to the metal base 10, the housing 20 and the feedthrough device 30 do not have structures capable of supporting optical components, and thus the lid does not independently form a hermetic space for accommodating said optical components. Referring to FIG. 1 and FIG. 2, when the lid is coupled to the metal base 10, the housing 20, the feedthrough device 30, the top cover 50, and the metal base 10 form a hermetic space SP together, in which the housing 20 and the feedthrough device 30 form the sidewalls of the hermetic space SP, the top cover 50 forms the top of the hermetic space SP, and the metal base 10 forms the bottom of the hermetic space SP.

In one embodiment, the at least one light transmission window 40 may be a sapphire window, but the present disclosure is not limited thereto. In one embodiment, the surface of the light transmission window 40 may be plated with a high-transmittance coating while leaving a sufficient light aperture to ensure optical output.

In one embodiment, the feedthrough device 30 may be a ceramic feedthrough device. In one embodiment, the feedthrough device 30 may include a first routing layer 32 and a second routing layer 31, which serve as independent signal input terminals. In one embodiment, the feedthrough device 30 may include the first routing layer 32 for high-speed signal power supply and the second routing layer 31 for direct current (DC) power supply. In one embodiment, the first routing layer 32 and the second routing layer 31 may be stacked on the metal base 10 to form a stepped shape.

FIG. 7 is a side view of an optical module according to another embodiment of the present disclosure, and FIG. 8 is a partially enlarged top view of the optical module shown in FIG. 7.

According to one embodiment, the optical module 2 may include the optical transmission component 1 and a substrate 60. Since the optical transmission component 1 has already been described above, its repeated description will be omitted in this embodiment.

In one embodiment, the substrate 60 may be a printed circuit board component. In one embodiment, the metal base 10 of the optical transmission component 1 may be a metal plate or a ceramic plate coupled to the printed circuit board component.

In one embodiment, the substrate 60 may include a through opening 610. In one embodiment, the covered area 100 and the exposed area 110 of the metal base 10 may correspond to the through opening 610. In one embodiment, the hermetic space SP may correspond to the through opening 610. In one embodiment, at least a portion of the lid may be disposed in the through opening 610. As shown in FIG. 7, a portion of the housing 20 and a portion of the feedthrough device 30 are disposed in the through opening 610.

In one embodiment, the active optical component 70 and the passive optical component 80 may be arranged along the longitudinal direction D1. In one embodiment, the housing 20 may be disposed between two edges of the through opening 610 in the lateral direction D2, which is substantially transverse to the longitudinal direction D1.

In one embodiment, the metal base 10 of the optical transmission component 1 may be coupled to the substrate 60. In one embodiment, the metal base 10 may be partially coupled to the substrate 60.

In the embodiment of the optical module 2, referring to FIG. 7 and FIG. 8, the active optical component 70 may include a laser diode 710, and the passive optical component 80 may include an optical isolator 820, a Z-block 830 and a collimator 840. The optical module 2 may further include a thermoelectric cooler 720 and a thermistor 810, and the laser diode 710 is coupled to the thermoelectric cooler 720 for heat dissipation. In one embodiment, the optical module 2 may further include at least one optical lens 90. In one embodiment, the optical lens 90 may be disposed in the covered area 100. In one embodiment, the optical lens 90 may also be disposed within the hermetic space SP. In one embodiment, the number of laser diodes 710 may be eight, and the number of optical lenses 90 may also be eight.

In one embodiment, the active optical component 70 disposed in the covered area 100 may be optically coupled to the passive optical component 80 disposed in the exposed area 110 through the light transmission window 40.

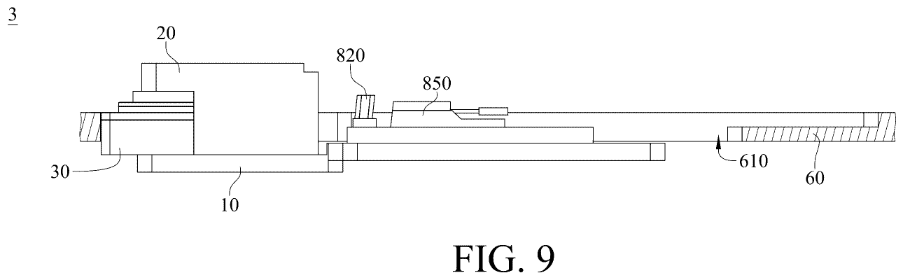

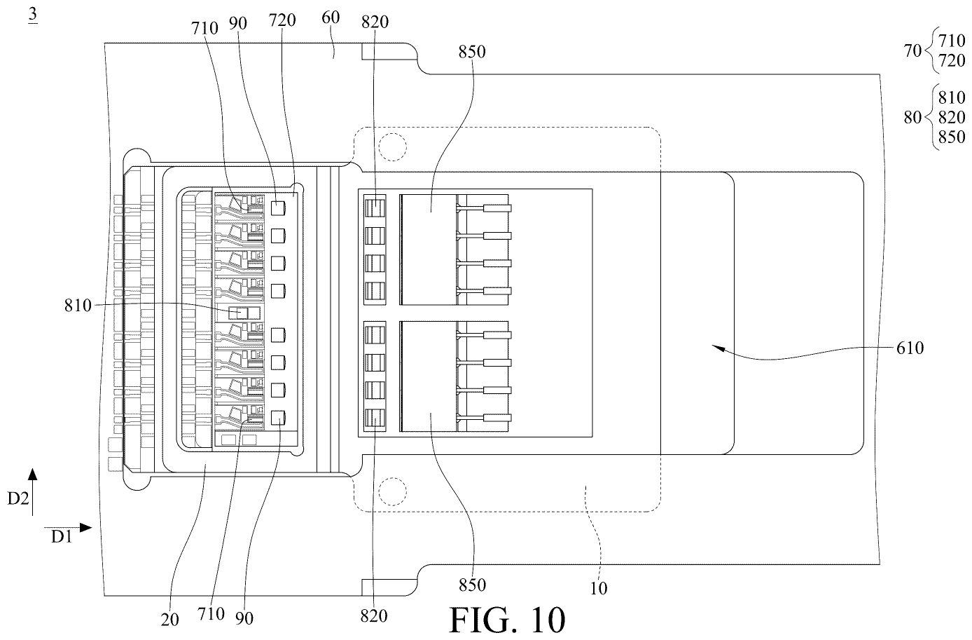

FIG. 9 is a side view of an optical module according to yet another embodiment of the present disclosure, and FIG. 10 is a partially enlarged top view of the optical module shown in FIG. 9.

According to one embodiment, the optical module 3 may include the optical transmission component 1 and the substrate 60. As the optical transmission component 1 has already been described above, repeated descriptions will be omitted in this embodiment. Furthermore, since the optical module 3 has a structure similar to that of the optical module 2, repeated descriptions thereof will also be omitted.

In the embodiment of the optical module 3, referring to FIG. 9 and FIG. 10, the active optical component 70 may include the laser diode 710, and the passive optical component 80 may include an optical isolator 820 and an optical fiber array 850. The optical module 3 may further include a thermoelectric cooler 720 and a thermistor 810, and the laser diode 710 is coupled to the thermoelectric cooler 720 for heat dissipation. In one embodiment, the optical module 3 may further include the optical lens 90. In one embodiment, the optical lens 90 may be disposed in the covered area 100. In one embodiment, the optical lens 90 may be disposed within the hermetic space SP. In one embodiment, the number of laser diodes 710 may be eight, the number of optical lenses 90 may be eight, and the number of optical isolators 820 may be eight.

Similar to the embodiment of the optical module 2, in one embodiment of the optical module 3, the active optical component 70 disposed in the covered area 100 may be optically coupled to the passive optical component 80 disposed in the exposed area 110 through the light transmission window 40 embedded in the housing 20.

An optical module according to an embodiment of the present disclosure may be applied to an optical transceiver. The optical transceiver may include a housing, and the optical module is accommodated in the housing. The substrate of the optical module may be exposed from the housing to allow electrical connection between the optical transceiver and external apparatus such as network switches. The optical transceiver may further include a fiber optic connector, such as an LC connector or an MPO connector, which is optically coupled to the passive optical component of the optical module or serves as part of the passive optical component.

In view of the above description, according to the optical module disclosed in the embodiment of the present disclosure, by coupling the active optical component to the covered area and the passive optical component to the exposed area, the manufacturing cost can be reduced while maintaining the reliability of the optical module. This configuration is compatible with optical modules of different specifications. During the manufacturing process, specific optical components are arranged at predetermined positions on the metal base according to product specifications, and then the lid is placed to seal the optical components. Since optical modules with different specifications can be assembled using a base and lid of a single size, this design enhances process flexibility.

The embodiments are chosen and described in order to best explain the principles of the present disclosure and its practical applications, to thereby enable others skilled in the art to best utilize the present disclosure and various embodiments with various modifications as are suited to the particular use being contemplated. It is intended that the scope of the present disclosure is defined by the following claims and their equivalents.

What is claimed is:

1. An optical module, comprising:
a substrate;
a metal base coupled to the substrate;
a lid having an annular bottom surface, the annular bottom surface monolithically coupled to the metal base to define a covered area and an exposed area at a side of the metal base, and the annular bottom surface surrounds the covered area;
an active optical component coupled to the metal base; and
a passive optical component coupled to the metal base;
wherein the active optical component is disposed within the covered area, and the passive optical component is disposed within the exposed area.

2. The optical module of claim 1, wherein the lid further comprises a housing, a feedthrough device, and a top cover, the housing and the feedthrough device is coupled to the metal base, the housing comprising at least one light transmission window, the active optical component is optically coupled to the passive optical component through the at least one light transmission window, and the top cover is coupled to the housing.

3. The optical module of claim 2, wherein the housing and the feedthrough device form the annular bottom surface together.

4. The optical module of claim 1, wherein the substrate has a through opening, the covered area and the exposed area correspond to the through opening, and at least a portion of the lid is disposed within the through opening.

5. The optical module of claim 4, wherein the lid comprises a housing, the housing has at least a portion of the annular bottom surface, the active optical component and the passive optical component are arranged along a longitudinal direction, and the housing, in a lateral direction substantially transverse to the longitudinal direction, is disposed between two edges of the through opening.

6. The optical module of claim 1, wherein the active optical component and the passive optical component are disposed on the same optical plane.

7. The optical module of claim 1, wherein the active optical component comprises a plurality of optical communication units, and the passive optical component comprises at least one of an optical fiber array, an optical isolator, a Z-block, and a collimator.

8. The optical module of claim 7, further comprising at least one optical lens, and the at least one optical lens is disposed within the covered area.

9. The optical module of claim 1, wherein the annular bottom surface is coupled to the metal base via soldering.

10. An optical module, comprising:
a substrate;
a metal base coupled to the substrate;
a lid having an annular bottom surface, the annular bottom surface monolithically coupled to the metal base via soldering so that the lid and the metal base together form a hermetic space;
an active optical component coupled to the metal base and disposed within the hermetic space; and
a passive optical component coupled to the metal base and disposed outside the hermetic space.

11. The optical module of claim 10, wherein the lid comprises a housing, a feedthrough device, and a top cover, the housing and the feedthrough device are coupled to the metal base, the housing comprises at least one light transmission window, the active optical component is optically coupled to the passive optical component through the at least one light transmission window, and the top cover is coupled to the housing.

12. The optical module of claim 11, wherein the housing and the feedthrough device form the annular bottom surface together.

13. The optical module of claim 10, wherein the substrate has a through opening, the hermetic space correspond to the through opening, and at least a portion of the lid is disposed within the through opening.

14. The optical module of claim 13, wherein the lid comprises a housing, the housing has at least part of the annular bottom surface, the active optical component and the passive optical component are arranged along a longitudinal direction, and the housing, in a lateral direction substantially transverse to the longitudinal direction, is disposed between two edges of the through opening.

15. The optical module of claim 10, further comprising at least one optical lens, wherein the active optical component comprises a plurality of optical communication units, and the passive optical component comprises at least one of an optical fiber array, an optical isolator, a Z-block, and a collimator, and the at least one optical lens is disposed in the hermetic space.
